(19) United States
(12) Patent Application Publication
(10) Pub. No.: US 2003/0158803 A1
(43) Pub. Date: Aug. 21, 2003

(54) System and method for estimation of asset lifetimes

(76) Inventors: Christian J. Darken, Riverton, NJ (US); William Hasling, West Windsor, NJ (US); Markus Loecher, Princeton Jct., NJ (US); Andreas Mueller, Nuernberg (DE)

Correspondence Address: Siemens Corporation, Intellectual Property Department, 186 Wood Avenue South, Iselin, NJ, 08830, US

(21) Appl. No.: 10/324,397

(22) Filed: Dec. 20, 2002

Related U.S. Application Data
(60) Provisional application No. 60/342,941, filed on Dec. 20, 2001.

(51) Int. Cl. G06F 17/60

(52) U.S. Cl. 705/36

(57) ABSTRACT

This invention relates to the estimation of asset lifetimes. An embodiment of the invention includes a method for estimation of asset lifetimes, that has the steps of inputting historic asset data into a system, generating a wear index for an asset based on the historical asset data, computing an amount of wear of an asset based on the wear index, and generating a remaining life of the asset based on the amount of wear of the asset.

### CROSS REFERENCE TO RELATED APPLICATION

This application claims the benefit of U.S. Provisional Application Serial No. 60/342,941, filed on Dec. 20, 2001, which is incorporated by reference herein in its entirety.

### FIELD OF THE INVENTION

This invention relates to a generic computer based approach to the estimation of asset lifetimes that can be used in conjunction with predictive maintenance principles.

### BACKGROUND OF THE INVENTION

Maintenance is a necessary part of operating machines because components and equipment will fail or break down frequently without maintenance. Since repair causes various costs, a goal is to keep these costs as low as possible in addition to putting the equipment back into service as quickly as possible.

There are different types of maintenance principles, each of them being a result of its respective time period's demands. The history of maintenance may be divided into three generations.

The first generation may be settled in the time prior to World War II, when the grade of industrial mechanization was low and the existing equipment was “simple and over-designed.” Hence it was reliable and easy to repair. Consequently, downtimes did not matter as much as today. Systematic maintenance was virtually non-existent except for simple tasks such as cleaning and lubrication. The maintenance principle used during this time period is known as Run-To-Failure Management, that is, repair equipment only when it is broken.

The second generation may be set to cover the period after World War II into the mid-1970's. Since the demands for all kinds of goods increased during wartime while manpower was dropping, it became necessary to increase plant mechanization in addition to utilizing equipment with higher sophistication. Since industry was more and more depending on complex machinery, maintenance had to meet the demands of higher availability, longer equipment life, and lower costs. As a result, the problems of breakdowns and downtimes became more apparent. The idea was that failures should better be prevented, so the concept of Preventive Maintenance came into being. Equipment was now checked regularly at fixed intervals, so that the occurrence of major breakdowns became less likely. While this technique is quite useful at first glance, it is yet not overly satisfactory for capturing failures occurring within intervals or for highly automated or critical machinery. This is due to the large amount of capital tied up in modern equipment, as well as, the duration of the overall repair process. Preventive Maintenance relies on previously fixed statistics or experiences concerning certain types of assets, and, as such, proves relatively inflexible. Different modes of operation for various assets are not considered, despite the fact that those modes have a great influence on the lifetime of an asset. Those modes of operation show unanticipated effects that could increase the downtime needed for repair.

A weakness of Preventive Maintenance can be demonstrated by a short example. A car's motor oil should be replaced every 5,000 miles or three months. This Preventive Maintenance does not take into account the condition the asset, that is, the motor oil, is in. It may well be the case that over time unnoticed events occurred on the motor, resulting in the need for earlier replacement of the oil. Retaining the Preventive Maintenance schedule, may cause the motor oil not to be replaced for a long period of time. This could result in severe engine damage. As a consequence, repair of the engine is now required, with the result of prolonged car downtime. If the condition of the oil could be determined, the failure could be detected by drawing conclusions from the worsened oil condition. The Preventive Maintenance interval would not have to be completed for the motor oil to be changed and major repair would become less likely.

A solution to this dilemma came about in the period of the third generation that began around 1975. Due to increasing complexity and automation, along with increasing criticality of failures, the expectations of maintenance rose to higher availability, higher reliability, greater safety, better product quality, environmental protection, longer equipment life, and greater cost effectiveness. Since reliability has grown more and more important to customer service, equipment failures and downtimes not only greatly affect the duration of the production process, the failures and downtimes equally affect customer service. Additionally, the increase in complexity and grade of automation not only led to an increase of the prime cost of the sophisticated equipment but also led to an increase in the cost of the associated necessary maintenance. These factors have led to the principle of Predictive Maintenance.

Predictive Maintenance is not intended to be a pure substitute for traditional existing maintenance concepts. Predictive Maintenance should be considered an additional feature of those concepts. There are many benefits to utilizing Predictive Maintenance. Some examples of these benefits are now described.

To begin with, there are fewer equipment failures since equipment condition is constantly being monitored allowing for earlier detection of malfunctions. There is less equipment downtime since the repair time needed to fix minor problems is shorter. The ability to detect equipment failures at an earlier stage allows for a reduction of spare parts inventory. Equipment life tends to be prolonged since less major failures occur. Increased production can result since equipment downtime is lessened. There is an improvement in operator safety since major equipment failure occurs less often. Acceptance testing of new equipment can be accomplished by checking for deviations from an equipment manufacturer's specifications. Similarly, verification of repairs can be obtained by comparing before and after readings of various equipment parameters. Maintenance costs are lower and profitability can increase since equipment operating costs are lowered.

A Predictive Maintenance System usually has four major components. Field data collectors make up the first component. These hand held devices offer features ranging from simple overall metering to analyzing functions. The collectors are used for manually entering data in a Predictive Maintenance system that cannot be obtained from an online source.

The second component is a sensor. The sensors are responsible for obtaining data directly from the equipment. Since there is a vast amount of equipment, there are a vast amount of sensors suited for every type of equipment.

The third component is a host computer. The host computer is the main component and has to have capabilities for data storage, evaluation, analysis, and report generation.

The fourth component is software. This component may be considered to be the brain of every Predictive Maintenance system. Generally, the system should be able to accurately monitor the performance of single pieces of equipment and alert the operating staff concerning deviations from normal equipment operating conditions. The software should have a minimum set of features. The software should be capable of performing automatic trending and diagnostics for predicting potential equipment failures and deriving diagnoses from supplied equipment parameter values. The software should have the capability of automatically reporting alarms for equipment that is likely to reach alarm limits. The software should be capable of data exchange for obtaining meter readings and transferring those readings to a computer maintenance management system. Additionally, the software should be simple to operate yet rich in complex features. The term Computerized Maintenance Management System (“CMMS”) identifies software systems that provide specialized functionality for the improvement and optimization of required maintenance.

While some software is available for Predictive Maintenance Systems, a need exists for a Predictive Maintenance System that incorporates wear index modeling to provide a lifetime estimation of equipment.

### SUMMARY OF THE INVENTION

A method according to an embodiment of the invention for estimation of asset lifetimes is described within the application. The method comprises inputting historic asset data into a system, generating a wear index for an asset based on the historic asset data, computing an amount of wear of an asset based on the wear index, and generating a remaining life of the asset based on the amount of wear.

The embodiments of the present invention will become more apparent from the following detailed description of illustrative embodiments thereof, which is to be read in connection with the accompanying drawings.

### BRIEF DESCRIPTION OF THE DRAWINGS

FIG. 1 is a block diagram illustrating wear index generation according to an embodiment of the present invention.

FIG. 2 is a block diagram illustrating a schematic sequence of increment computation according to an embodiment of the present invention.

FIG. 3 illustrates architecture of a lifetime estimation system according to an embodiment of the present invention.

FIG. 4 is a flow diagram illustrating a training sequence for assets according to an embodiment of the present invention.

FIG. 5 is a flow diagram illustrating a training sequence for parts according to an embodiment of the present invention.

FIG. 6 is a flow diagram illustrating a lifetime estimation sequence according to an embodiment of the present invention.

FIG. 7 is a block diagram of a lifetime estimation model according to an embodiment of the present invention.

FIG. 8 is a block diagram of structures of a lifetime estimation system according to an embodiment of the present invention.

FIG. 9A is a block diagram of an entity relationship for asset handling according to an embodiment of the present invention.

FIG. 9B is a block diagram of an entity relationship for asset and spare part handling according to an embodiment of the present invention.

FIG. 10 is a block diagram of data structure ListOfUses according to an embodiment of the present invention.

FIG. 11 is a block diagram of a method for lifetime estimation of an asset according to an embodiment of the present invention.

FIG. 12 is a graph illustrating a graphical method of lifetime estimation according to an embodiment of the present invention.

### DETAILED DESCRIPTION OF PREFERRED EMBODIMENTS

Embodiments of the present invention will be described and can be used for lifetime estimation of equipment.

A Component Object Model (“COM”) is a binary standard that enables objects to interoperate in a networked environment regardless of the language in which they were developed or on which computers they reside.

This definition points out essential facts of COM. It is a specification of the way software components need to be structured on the binary level to be dynamically interchangeable and to be able to communicate with each other, thus achieving reusability of binary components. As such it does not depend on a specific programming language but can be used with any procedural language. Since COM defines the necessary standard behavior, the components can be stored on any computer within the network and still interact. Due to this transparent relocation over networks, such components are treated the same, whether they are spread over many computers or stored on one single machine. However, while being basically an object-oriented concept, COM is not a specification on structuring or writing object-oriented source code, since it only refers to the structural layout of compiled objects at the binary level. It is not fully object-oriented in the traditional sense, since it does not support implementation inheritance, that is, the inheritance of actual implementation or behavior, across components, but only within a component's actual implementation. It fully supports and relies on interface inheritance, that is, of the specification of behavior.

The key concept in COM is the strict separation of interfaces and actual implementations. Hiding the actual implementation details of methods or classes and exposing only the information necessary for using them is a major requirement in the idea of COM. However, since COM is a specification for the binary level, this encapsulation has to take place not only in the structure of the source code but also in the binary format created by the compiler. At the binary level, a class in object-oriented languages usually is interface and implementation at the same time. Thus, upon changes in the class implementation, the interface as part of this binary object would also be changed. To avoid this weakness, in COM implementations and interfaces are considered as being of two different kinds of entities and as such, are realized as two separate kinds of classes. Then one class only contains the interface to a data type and the other class contains the data type's actual implementation. Thus, the object's implementation can be altered without affecting its interface. On the source code level this concept is put into reality by defining the interface classes as being abstract base classes, with the implementation classes as derived ones. In terms of COM, the interface holding the specification for a group of related functions is not considered a class or even a component, since it cannot be instantiated due to its lack of carrying information about the objects implementation.

Another characteristic of COM interfaces, components accessing other components' functions only have points to their interfaces through which the functions within the interfaces can be accessed. Components can implement more than one interface, since interfaces are mere groupings of logically related functions. When naming these interfaces, name collisions are avoided by assigning computer-generated unique identification numbers. Furthermore, the attribute interfaces are not versioned.

The fundamental characteristics of COM include:

1. A binary standard to enable various components to call each other's functions. This defines the actual memory layout of components' interfaces, as well as, a standard way for calling the functions contained in these interfaces.

2. A base interface for every component, providing a way for other components to dynamically discover the interfaces implemented by a particular component. The base interface also provides a mechanism called “reference counting” that allows components to track their own lifetime. Thus they are able to delete themselves from memory when they are no longer required.

This special base interface, which is always called IUnknown and is inherited by all COM interfaces, has to be implemented by every COM component, otherwise the components are not considered COM components.

IUnknown contains three methods by definition, QueryInterface, AddRef, and Release. QueryInterface represents the mechanism that makes it possible for other components to find out at run time whether a particular component supports a requested interface or not. If it does it supplies a pointer to the interface if the interface is present. AddRef is called to increment the reference count and to signal that the number of components using it has grown. Release is called when an interface is no longer needed.

3. A method of uniquely identifying components and their interfaces. This is achieved by assigning every component and interface a special identification number, called a Globally Unique Identifier (“GUID”) that is guaranteed to be unique in time and space. The uniqueness can be accomplished by utilizing the computer's network card and timestamp information during the moment of creation.

4. A “component loader” for setting up and managing component interactions. This is necessary if components are used that do not run within the same process or on the same computer.

All equipment ages and wears regardless of its type or nature. However, there are significant differences in the way that the wearing takes place. Equipment can wear due to influences such as mechanical load, friction and its resulting temperature, characteristics of the material the equipment consists of or is used on, the maintenance work performed on the equipment, and environmental factors, such as humidity and temperature. Depending on the type and nature of equipment, some influences can be considered to be predominant. For example, bearings used in electrical motors mainly wear due to the mechanical load the bearings are exposed to, while the electrical influences have little or no effect on wear. Light bulbs, on the other hand, are primarily affected by the effects caused by current, specifically by the events of switching current on or off, while mechanical influences to a large extent, can be ruled out.

Identifying specific factors of influence and their significance for the course of wear of a particular type of equipment allows a special dimensionless number to be utilized, called the wear index. The wear index indicates the virtual age of a particular item. Unlike conventional age, which is determined merely by the lifetime passed since an item has been installed in its designated field of use, virtual age is based on the influences an item has been exposed to during its lifetime. These influences can be either asset-specific or environmentally caused and, as such, are physically measurable.

A condition is the entirety of values an asset's indicators have adopted at a certain time. An asset's indicators can include, but are not limited to, hours of service, temperature, lubricant level, and rotor temperature. Not all indicators are used for all assets. For example, a light bulb would not have a lubricant level.

A use is the total volume of conditions that have occurred during the lifetime of the asset or part associated with the conditions, that is, all data characterizing the life of an item.

The wear index, being a virtual measurement for wear and aging, is an increasing value. Once an item is in use for a certain period of time, its basic wear cannot be undone.

The wear index is derived from a set of input data from many already failed specimen of a particular type of equipment, that is, the training set. By processing the training set, a server should be able to determine the average wear behavior items of a certain type exhibit. This determination can then be used to predict an asset's remaining lifetime. A function ƒ(\vec{c}) is used that allows for computing an increment of wear for each condition entered for a new item of the respective type. Thus a current wear index (or virtual age) w_{curr} for an asset would be the sum of all previous N wear increments

$${w}_{curr} = {\sum }_{i = 1}^{N} f ( {\vec{c}}_{i} )$$

For the wear increment function ƒ, an additive model of the form

$$f ( {\vec{c}}_{i} ) = {\sum }_{j = 1}^{M} {a}_{j} {g}_{j} ( {\vec{c}}_{i} )$$

is utilized, with

gⱼ(\vec{c}ᵢ)

being arbitrary nonlinear functions. Hence for each item k in the training set, the wear index wₖ can be computed by

$${w}_{k} = {\sum }_{i = 1}^{N} {\sum }_{j = 1}^{M} {a}_{j} {g}_{j} ( {\vec{c}}_{i , k} ) = {\sum }_{j = 1}^{M} {a}_{j} {G}_{j , k} , with the matrix {G}_{j , k} = {\sum }_{i = 1}^{N} {g}_{j} ( {\vec{c}}_{i , k} ) .$$

Furthermore, the virtual age of an already failed item is assumed to be a constant. However, the number of conditions do not necessarily have to be the same for each item in the training set. Therefore missing input data can be assumed. Missing data could result from either human failure, for example, not obeying a demanded sampling rate of twice a day and instead measuring data only every two days, or technical problems, for example, undiscovered broken sensors. Thus, the conditions in each set with missing data can either still cover an item's entire life but imply a lower sampling rate, or although the sampling rate remained the same, cover only a part of the item's life. Since time does not play a role in this wear index model, it cannot be determined by looking at the series of conditions whether a series covers the whole life or not. Such situations could have a dramatic impact on the quality of the model. Therefore, as a solution, the items with the longest histories of conditions are set to a virtual age of 1 and the assets having shorter histories may consequently be set to the respective fractions. For example, one item shows a history of 1000 conditions while another only shows 800. Since both are of the same type, the assumption of 200 missing conditions is made. Thus the first item would be assigned the virtual age of 1 and the second one would be assigned 0.8. The virtual ages are stored in a vector \vec{b} of size K, which is the number of items in the training set. Now the weights aⱼ can be optimized via linear regression.

G·\vec{a}=\vec{b}

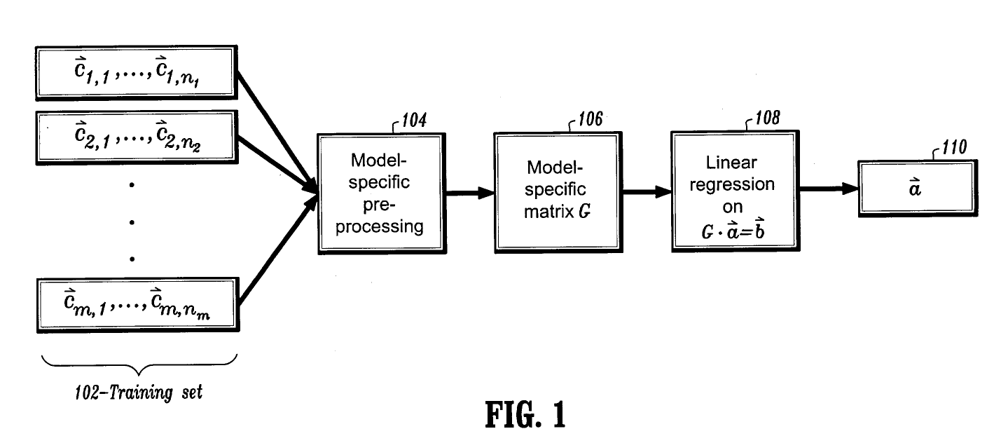

Referring to FIG. 1 which is a block diagram illustrating wear index generation according to an embodiment of the present invention, when input to the core procedure, a training set 102 consists of pure raw data, that is, a series of either measured or derived values. Depending on factors as the sampling frequency and the typical lifetime for items, the training set can be of a considerable size. In the case of x-ray tubes, for example, a training set could consist of up to 60 individuals with up to 10000 conditions each and up to 19 variables for the conditions. The preprocessing step 104, which is dependent on the respective model employed, that is, on the selected gⱼ(\vec{c}ᵢ), condenses the training data to the flattened matrix G 106, which consequently depends on the selected model. This step also determines the virtual ages for each item that generates the vector \vec{b}. Then, the weights or coefficients need to be computed. This is accomplished by linear regression 108. The resulting vector \vec{a} 110 finally contains those values necessary for the function ƒ(\vec{c}).

The core procedure's basic output is the vector \vec{a} that holds the weights required by the wear increment function. Therefore, these weights need to be saved for later use. However, since the weights alone do not allow for the computation of increments, the function gⱼ also need to be saved. Thus, either the entire wear increment function has to be stored or plain information about the employed type of model has to be stored.

At a later time, by restoring the information and weights, the wear increment function for a particular type of equipment can be rebuilt and subsequently used for the computation of increments.

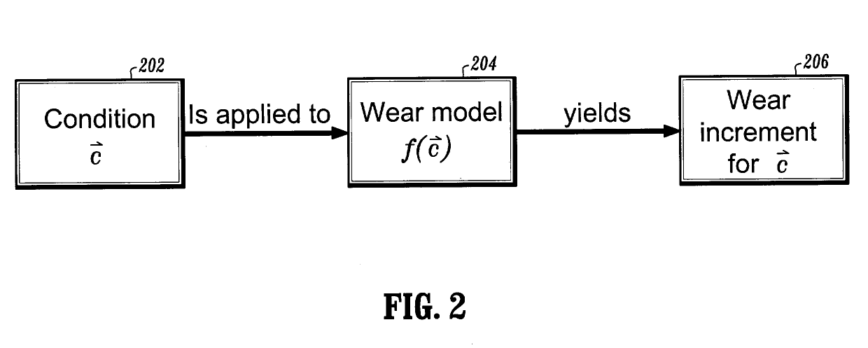

A schematic sequence of increment computation according to an embodiment of the present invention, is illustrated in FIG. 2.

Once the wear model for a particular type of equipment has been created, as described above, the computation of the current virtual age of an individual item of that type is straightforward. Every time a new set of values is available for an item, the condition \vec{c} 202 is applied to the wear increment function 204, which in turn computes the corresponding amount of wear 206. The interpretation of this process is that the wear increment values in \vec{c}are the result of some wear that occurred since the last measurements were taken. This is represented by the wear increment. Consequently, the wear the item has been exposed to thus far, w_{curr}, is the sum over all previous wear increments.

It is important, that the factor of time is completely neglected in the above computation, that is, the increments are independent of their time of occurrence. This is reasonable since wear is basically an irreversible process and therefore the order in which phases of stronger or weaker wear occur does not play an important role to the fact of total wear at a certain time.

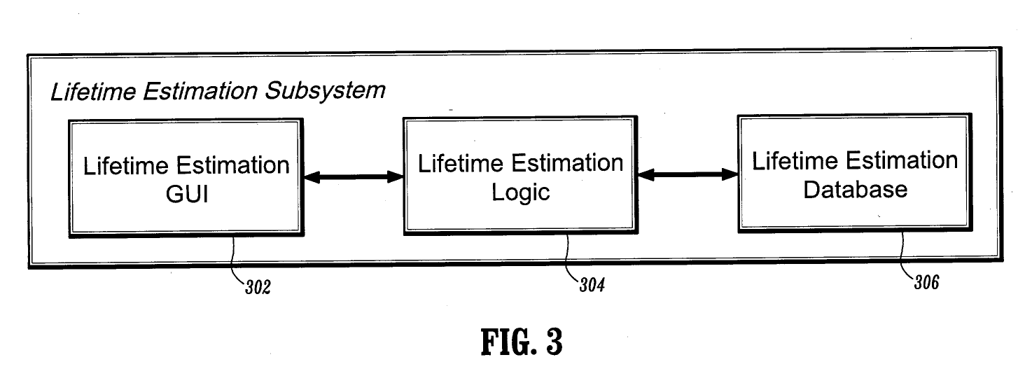

FIG. 3 illustrates the architecture and integration of a lifetime estimation system that incorporates a wear index model, according to an embodiment of the present invention. At the center of the architecture is lifetime estimation logic 304. The lifetime estimation logic 304 interfaces with a lifetime estimation database 306. The database is comprised of a set of tables that store lifetime estimation data, that is, the training set data previously described. The data is loaded into the database by a training sequence. The data can be accessed by a Lifetime Estimation graphical user interface (“GUI”) 302.

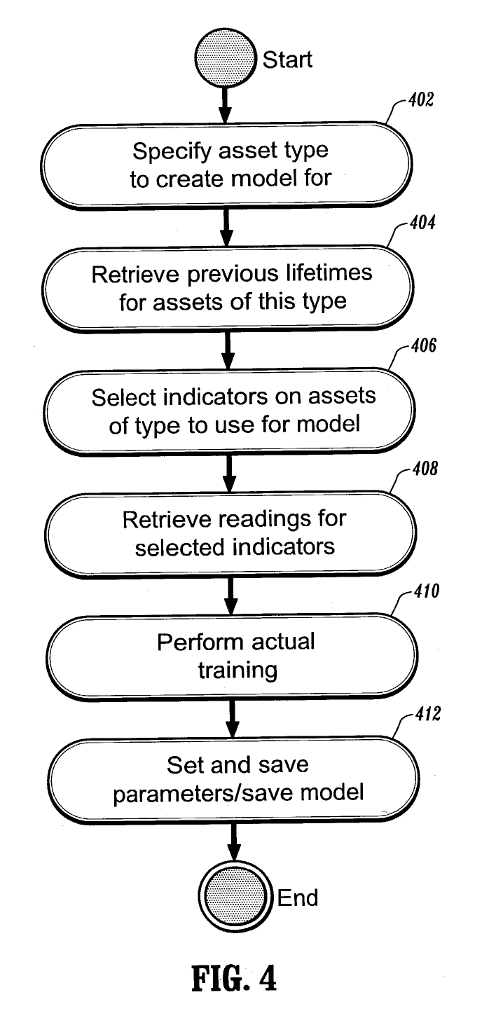

FIG. 4 is a flow diagram that illustrates a training sequence according to an embodiment of the present invention. The training sequence is comprised of several logical steps that are used to create a wear index model. The first step 402 specifies an asset type that a wear index model is created for. Since a method according to an embodiment of the present invention, can manage a large number of assets of differing types, the respective type of asset that the wear index model is created for needs to be specified. Next the lifetimes for assets of the type specified must be obtained 404 and entered into a table within the lifetime estimation database. The lifetime of an asset can be the period from the assets first installation to its deactivation, that is, it's final removal. After the lifetimes of assets have been entered into the table, indicators of the asset type must be specified 406. Indicators are used for measuring wear. The indicators can include, but are not limited to, hours of service, temperature, lubricant level, and rotor temperature. Not all indicators ate used for every asset type, for example, a tire would not have an indicator for lubricant level. After the indicators that will be used for a particular asset type are identified, the indicators' historic values for that asset type must be obtained 408 and loaded into a table 410. Once the indicators' historic values are loaded into the table, additional parameters 412, such as a wear index threshold, can be loaded into the lifetime estimation database. After all of the additional parameters that will be used for the particular asset type are loaded into the lifetime estimation database, the training sequence is finalized.

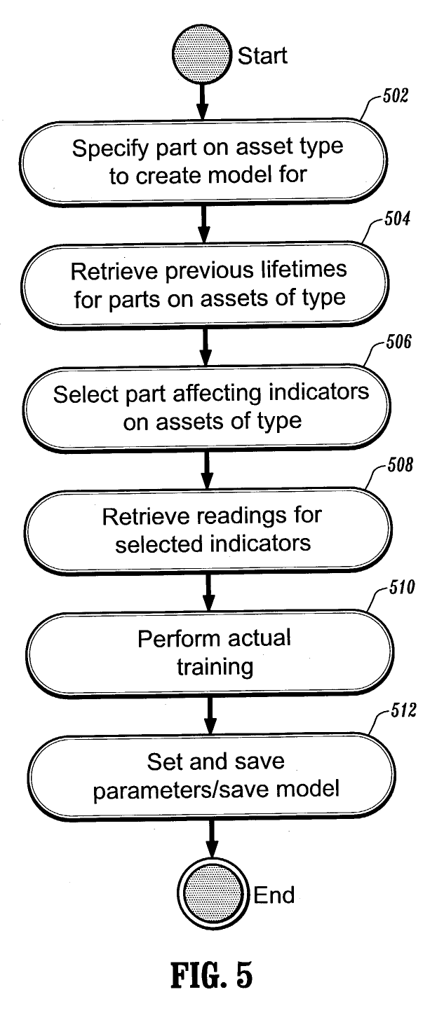

FIG. 5 is illustrative of a method according to an embodiment of the present invention that can be used as a training sequence for spare parts. Since spare parts can be used for assets of different types, it is necessary to not only name the desired part but also the asset type on which the wear behavior of that spare part type is being investigated 502. Additionally, the previous lifetimes of spare parts used for a particular asset needs to be obtained 504 and loaded into a table within the lifetime estimation database. The lifetime of a particular spare part is most likely shorter than the asset's lifetime. This is due to the fact that the spare part, for example, a fan belt, could have been replaced several times over the course of the asset's lifetime. Work orders that apply to the asset and contain the spare part being investigated can be used as a source of information for obtaining a spare part's lifetime. Once the spare parts lifetime is ascertained a set of indicators that apply to the spare parts needs to be obtained 506 and loaded into a table. The indicators can be, but are not limited to, hours of service, temperature, lubricant level, and rotor temperature. After the indicators that will be used for a particular spare part are identified, the indicators' historic values for that spare part must be obtained 508 and loaded into a table 510. Once the indicators' historic values are loaded into the table, additional parameters 512, such as a wear index threshold, can be loaded into the lifetime estimation database. After all of the additional parameters that will be used for the particular asset type are loaded into the lifetime estimation database, the training sequence is finalized.

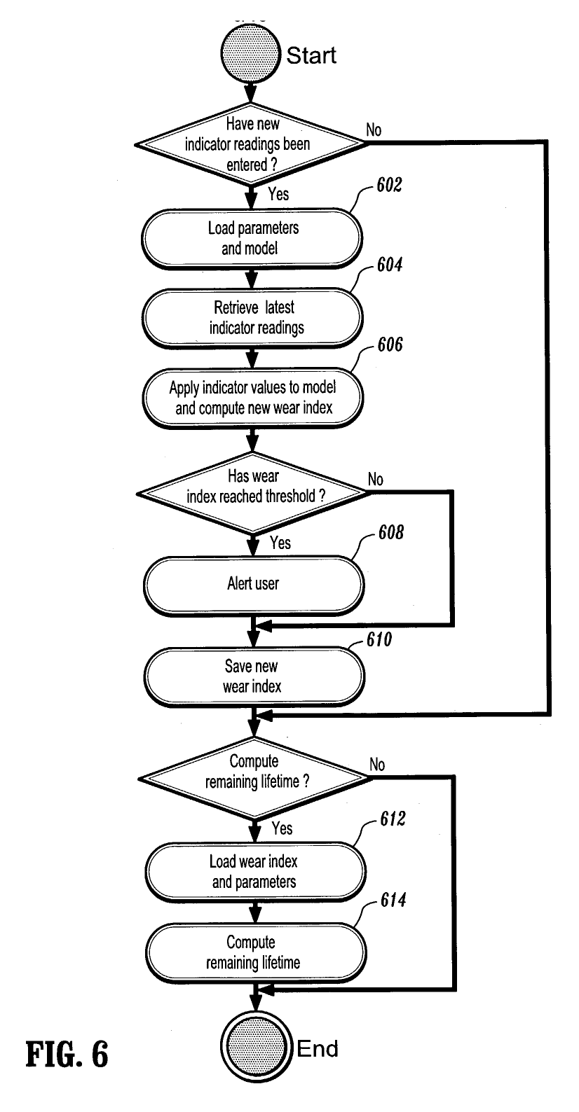

FIG. 6 illustrates a method of a lifetime estimation sequence according to an embodiment of the present invention. If the historic values of indicators have been loaded into a table within the lifetime estimation database, the parameters and the asset model type are selected 602, otherwise processing continues using the former wear index. The latest values for the indicators are obtained and entered into the database 604. The new indicator values are applied to the asset type model and a new wear index is computed as previously described 606. If a wear index threshold has been entered as a parameter and the new wear index reaches the wear index threshold 608, a user is notified that the asset's lifetime has been reached or is close to an end 610, otherwise processing continues. The newly computed wear index is saved 612. If the remaining lifetime of an asset is to be computed, the new wear index is loaded 614 and the remaining lifetime of an asset or spare part is computed 616, otherwise processing ends.

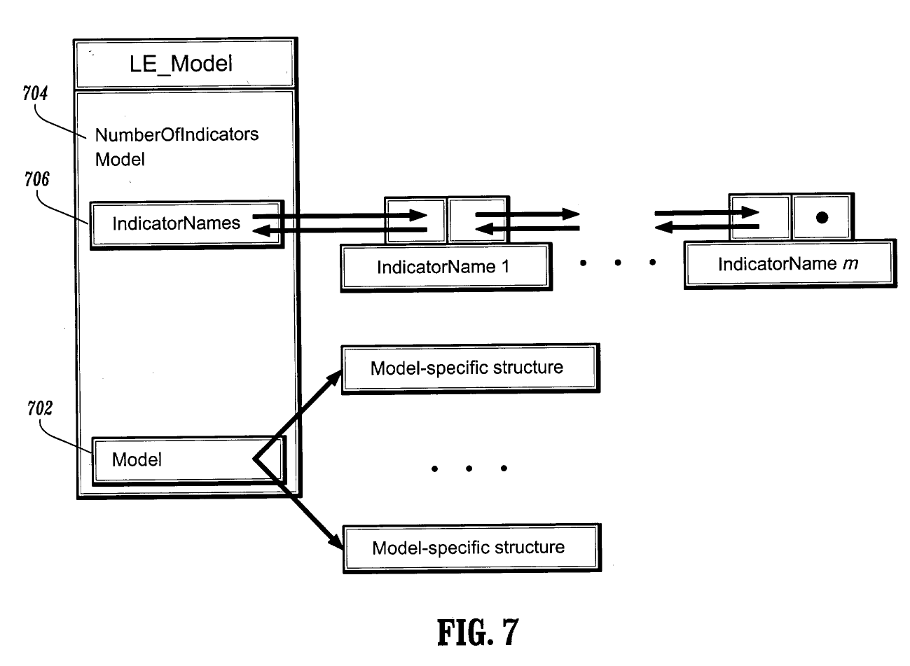

FIG. 7 illustrates a lifetime estimation model according to an embodiment of the present invention. To adjust the model for using different mathematical models, multiple pointers are specified to the actual structures for the respective mathematical model and a variable, called “Model” 702 is used to indicated the model used. Hence the operation of the lifetime estimation model is slightly different depending on whether a model is being created and stored or restored for a increment computation. During creation, the NumberOfIndicators 704 and IndicatorNames 706 are inserted during the training sequence described above. During restoration, the structure is completely filled at the start of the process.

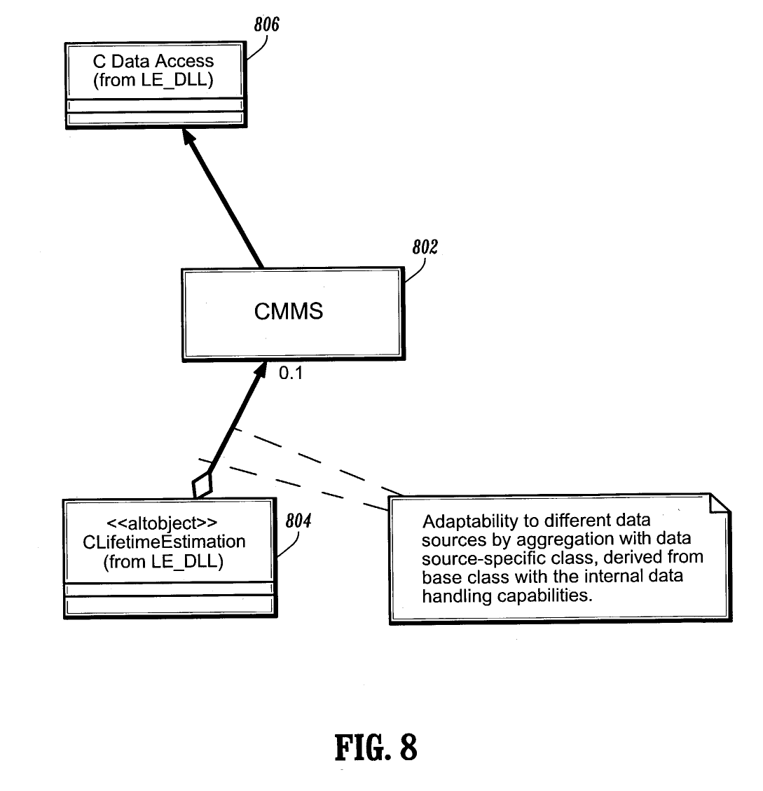

FIG. 8 illustrates how a structure is defined according to an embodiment of the present invention. The functionality required for data exchange from the data 802 is separated from that for carrying out the actual computations, that is, the data processing. This facilitates the data processing capabilities being exposed only to the graphical user interface (“GUI”) 806. A lifetime estimation class 804 can then be set up to contain all processing related methods that do not all need to be visible to the GUI 806. The class can contain two sets of methods, one that maps the sequences described in FIGS. 4 and 5 and another that constitutes the actual mathematical algorithms. This facilitates not having to modify the external interfaces should it be decided that different wear index models are to be used or added.

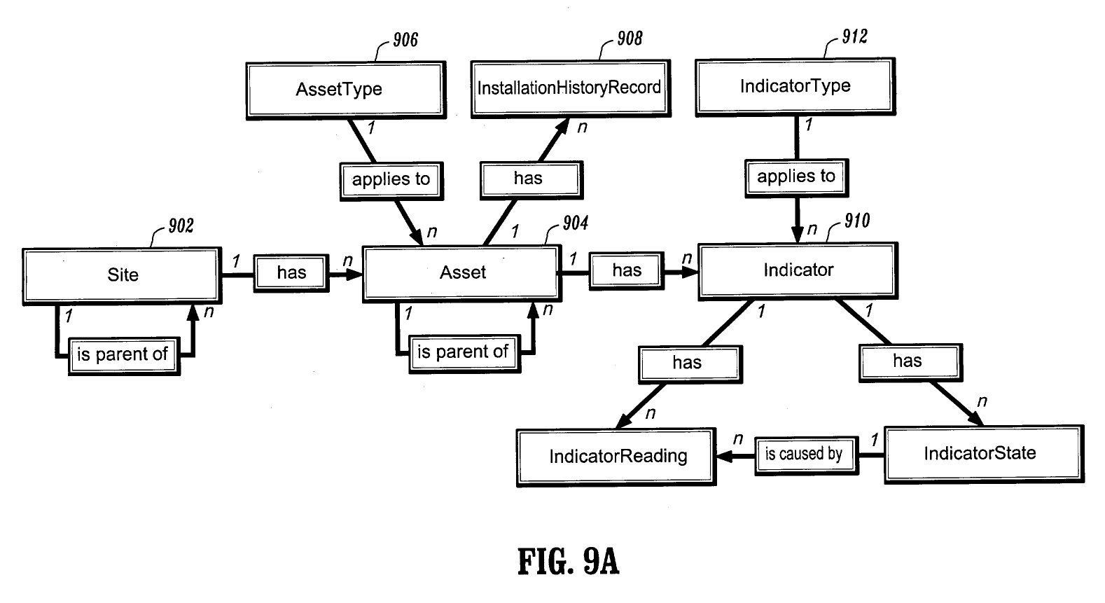

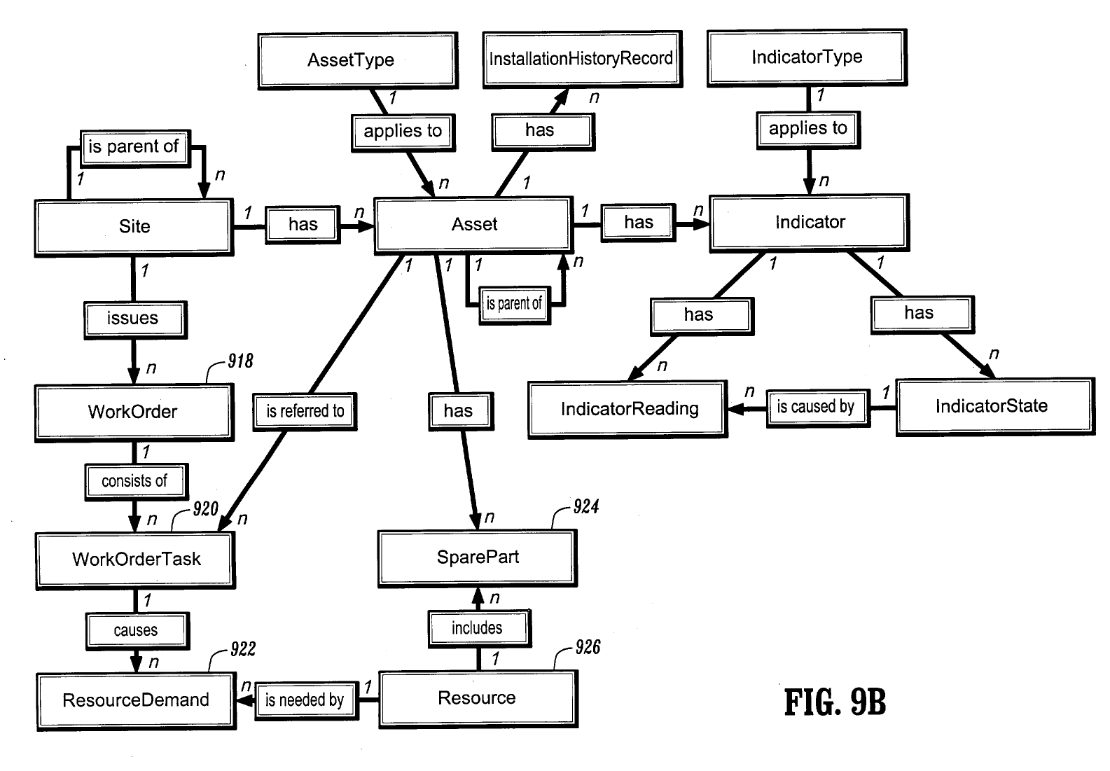

FIG. 9A illustrates an entity relationship diagram for handling assets according to an embodiment of the present invention. A site 902 can have one or many assets 904. The assets can be of one or many types 906, for example, copiers, printers, fax machines. The asset was installed at the site at a particular point in time, so the asset has an installation history 908. Each asset can have one or many wear indicators 910. The indicators are of varying types 912, for example, room temperature, air quality index, ink usage. The indicators have a particular state 914, for example, ink level, toner level. The indicator reading 916 is performed at a certain point in time to reflect the indicator state 914.

FIG. 9B illustrates an entity relationship diagram for handling assets and spare parts according to an embodiment of the present invention. The asset portion of the figure is identical to that of FIG. 9A. Each site further issues work orders 918, for example, a request for service. The work orders consist of one or many work order tasks 920, for example, replenishing toner cartridges. This replenishment of toner cartridges places a demand on resources 922, for example, one or many toner cartridges can be required to fulfill the work order task. Additionally, each asset has a need for one or many spare parts 924, for example, a copier drum. The spare parts needed to complete a work order task for a particular asset are obtained from a resource area 926, for example. a stock room.

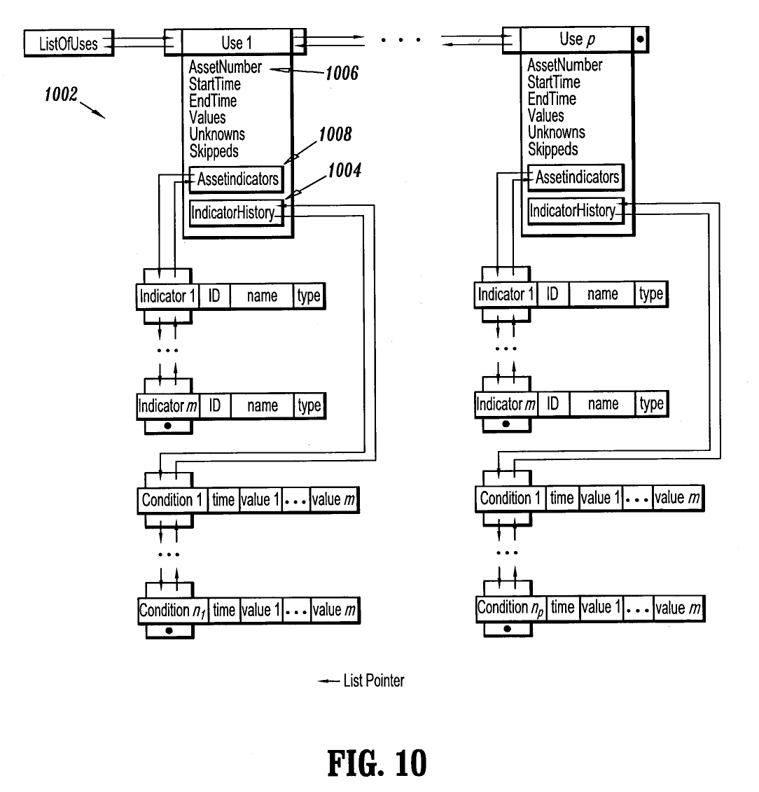

FIG. 10 is a block diagram of data structure ListOfUses 1002. ListofUses 1002 is defined and meant to store the training sets described above and shall only be modeled to logic. Since there would be a great number of conditions during an asset's lifetime, these conditions are mapped to a (doubly-)linked list of conditions, called IndicatorHistory 1004. Considering the fact that a training set would consist of data coming from a set of items (uses), this results in a linked list, that is, the actual ListOfUses. Thus, a list with elements that in turn contain lists is created. This list can grow large rather easily.

To operate the ListOfUses at a reasonable level of performance, special administrative information is added to the uses that allow for dynamic operation as the training sequence, described above, proceeds. The object-Ids of assets, called AssetNumber 1006, and the IDs of relevant indicators on each asset should be obtained. A list for the necessary indicator names and types, called AssetIndicators 1008, is also added. Additionally, start and end times of a lifetime of an asset and/or part are also required to be stored.

According to an embodiment of the present invention, the list operates in the following manner. For each “dead” item of a specified type one use is created that initially contains only the AssetId and the lifetime information. If the training sequence, previously described, was executed for assets, then the list would contain as many uses as failed assets p. If the training sequence was executed for parts, then the list would contain as many uses as the total number p of failed parts on assets. For example, if it is concluded from work orders that a part was replaced twice during a parent asset's lifetime, then three uses would result. Each use covers the lifetime of one of three parts and all three have the ID of the parent asset. The IndicatorHistories 1004 are “split”, that is, each history would contain values that occurred during the respective part's life.

At the next stage, all m common indicators are retrieved and stored in AssetIndicators 1008. Although the names and types are the same for each asset, a separate list of indicators for each use is needed since the IDs are different. All unwanted indicators are eliminated so the AssetIndicators 1008 get diminished, yielding the final m indicators to be used. Since all of the IDs of the respective common indicators are now available, the actual historic values are loaded and the IndicatorHistory 1004 is created for each use.

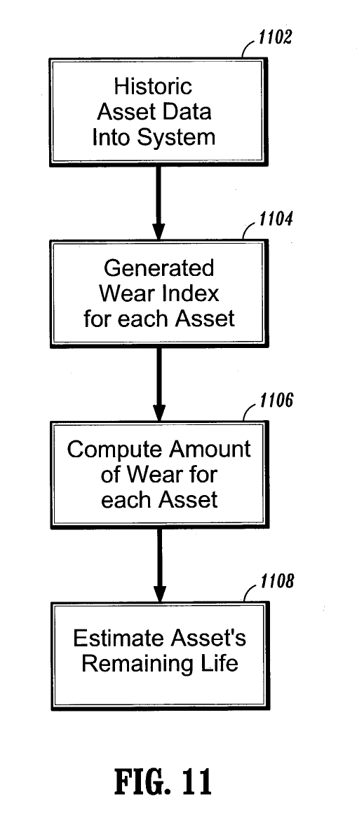

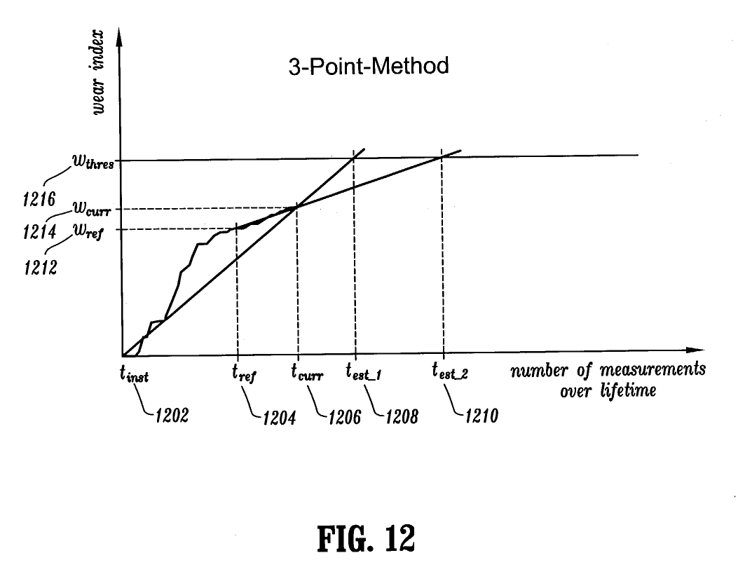

FIG. 11 illustrates a method for lifetime estimation of an asset according to an embodiment of the present invention. Historic maintenance data relating to an asset of a particular type is obtained. This data can be obtained from work orders, installation records, and any other relevant source. The historical data is entered into a system 1102 as previously described, that has a wear index model that can calculate a wear index for each item entered into the system. A wear index is generated for each asset that is to be evaluated 1104 as previously described. Once the wear index is calculated an estimated amount of wear for each asset is generated 1106 as previously described. The estimated amount of lifetime for an asset is calculated 1108. This will be described in reference to FIG. 12.

FIG. 12 illustrates a graph depicting a method of lifetime estimation according to an embodiment of the present invention, tᵢₙₛₜ 1202 of the graph represents the time the item has been installed (“installation time”). t_{ref} 1204 of the graph represents the time at which a certain previous wear index was reached (“reference time”). t_{curr} 1206 of the graph represents the time the most recent measurement was processed (“current time”). tₑₛₜ_{_{—}}₁ 1208 is the estimated time of failure 1. tₑₛₜ_{_{—}}₂ 1210 is the estimated time of failure 2. w_{ref} 1212 is the wear index that was the current wear index at time t_{ref} 1204 (“reference wear index”). w_{curr} 1214 is the wear index reached after processing the measurement at t_{curr} 1206 (“current wear index”). wₜₕᵣₑₛ 1216 is the threshold indicating failure of equipment.

To obtain the final amount of lifetime remaining the basic equation for a straight line is used, that is, y=m·x+b. Geometrically, two straight line fits and a modification of a time value depending on slopes, are performed. Therefore, five equations will be solved to gain a predicted value for remaining lifetime.

wₜₕᵣₑₛ=m*tₑₛₜ_{_{—}}₁+b

w_{curr}=m*t_{curr}+b

since this line always has its origin in the time-wear coordinate system's point of origin, intersection b is set to 0. The time have to be normalized by subtracting tᵢₙₛₜ. The above equations now become

$${w}_{thres} = \frac{{w}_{curr}}{{t}_{curr} - {t}_{inst}} \cdot ( {t}_{est\_ 1} - {t}_{inst} ) .$$

By resolving the above equation the desired value tₑₛₜ_{_{—}}₁ is determined.

$${t}_{est\_ 1} = \frac{{w}_{thres} \cdot ( {t}_{est\_ 1} - {t}_{inst} )}{{w}_{curr}} + {t}_{inst} .$$

Estimation time of failure 2, tₑₛₜ_{₁₃} ₂ is now determined. To compute tₑₛₜ_{_{—}}₂ a second straight line through points (t_{ref}, w_{ref}), (t_{curr}, w_{curr}) (tₑₛₜ_{_{—}}₂, wₜₕᵣₑₛ). Therefore,

wₜₕᵣₑₛ=m*tₑₛₜ_{_{—}}₂+b

w_{curr}=m*t_{curr}+b

w_{ref}=m*t_{ref}+b

The lines slope m and intersection b are obtained for the above equations yielding

$${w}_{thres} = ( \frac{{w}_{curr} - {w}_{ref}}{{t}_{curr} - {t}_{ref}} ) \cdot {t}_{est\_ 2} + ( {w}_{ref} - \frac{{w}_{curr} - {w}_{ref}}{{t}_{curr} - {t}_{ref}} \cdot {t}_{ref} )$$

Resolving the above equation yields the desired tₑₛₜ_{_{—}}₂.

$${t}_{est\_ 2} = \frac{( {w}_{thres} - {w}_{ref} + \frac{{w}_{curr} - {w}_{ref}}{{t}_{curr} - {t}_{ref}} \cdot {t}_{ref} ) ( {t}_{curr} - {t}_{ref} )}{{w}_{curr} - {w}_{ref}} .$$

The above steps have yielded two predicted times tₑₛₜ_{_{—}}₁, that holds the time at which the threshold will be reached if an item's overall use (and thus increase of wear) continues as during the item's whole life so far, and tₑₛₜ_{_{—}}₂ that holds the time at which the threshold will be reached if the asset will be used as it has recently been used. This could obviously result in a considerable difference since the mode of use for this item might have changed over time. The fraction, frac, of total wear, which the recent behavior of usage, starting at t_{ref} has caused, is derived. For example, if an engine has not been used very intensively at the beginning of its life, but has recently been running under heavy load, then this heavy-use period has caused a stronger increase in wear than the time before. Hence it can occur that, for example, 30% of the allowed wear has been reached just within a relatively short period of time, that is, in much less than 30% of the lifetime elapsed.

$$frac = \frac{{w}_{curr} - {w}_{ref}}{{w}_{thres}}$$

Since different modes of use affect the expected lifetimes of an asset in a prolonging or shortening manner, for example, if an asset is under heavier load than it used to be, the expected life will be diminished, determination of corrected estimated time of failure is now derived.

The above fraction of wear, frac, is caused by that period into a modification of expected lifetime. This is the fraction of difference of the two predicted times tₑₛₜ_{_{—}}₁ and tₑₛₜ_{_{—}}_{2.} The value tₑₛₜ_{_{—}}₁ is adjusted by either subtracting the fraction of time difference from tₑₛₜ_{_{—}}₁ if the increase of wear during the observed period would cause a shorter life, or the fraction of time difference is added, if the increase of wear would allow for a prolonged life. the final time, t_{final}, marks the point in time the threshold would be reached.

t_{final}=tₑₛₜ_{_{—}}₁−frac·|tₑₛₜ_{_{—}}₁−tₑₛₜ_{_{—}}₂|,tₑₛₜ_{_{—}}₂<tₑₛₜ_{_{—}}₁ or

t_{final}=tₑₛₜ_{_{—}}₁+frac·|tₑₛₜ_{_{—}}₁−tₑₛₜ_{_{—}}₂|,tₑₛₜ_{_{—}}₂>tₑₛₜ_{_{—}}₁ or

t_{final}=tₑₛₜ_{_{—}}₁,tₑₛₜ_{_{—}}₂=tₑₛₜ_{_{—}}₁

For simplification the first two cases are combined resulting in

t_{final}=tₑₛₜ_{_{—}}₁+frac·(tₑₛₜ_{_{—}}₁−tₑₛₜ_{_{—}}₂), tₑₛₜ_{_{—}}₂≠tₑₛₜ_{_{—}}₁ or

t_{final}=tₑₛₜ_{_{—}}₁,tₑₛₜ_{_{—}}₂=tₑₛₜ_{_{—}}₁

The remaining lifetime tᵣₑₘ is derived by subtracting the current clock time, which according to a preferred embodiment of the present invention, is the current system time t_{sys} from t_{final},

tᵣₑₘ=t_{final}—t_{sys}.

Examples of data structures, specifications of methods, and approaches for obtaining objects can be found in the appendix.

The teachings of the present disclosure are preferably implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more Central Processing Units (“CPUs”), a Random Access Memory (“RAM”), and Input/Output (“I/O”) interfaces. The computer platform may also include an operating system and micro instruction code. The various processes and functions described herein may be either part of the micro instruction code or part of the application program, or any combination thereof, which may be executed by a CPU. In addition, various other peripheral units may be connected to the computer platform such as an additional data storage unit and an output unit.

It is to be further understood that, because some of the constituent system components and steps depicted in the accompanying drawings may be implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

[image]

[image]

[image]

[image]

[image]

[image]

[image]

[image]

[image]

[image]

What is claimed is:

1. A method for lifetime estimation of assets comprising the steps of:
inputting asset data into a system;
generating a wear index for an asset based on said asset data;
computing an amount of wear of an asset based on said wear index; and
generating a remaining life of said asset based on said amount of wear.

2. The method of claim 1, wherein said asset data includes spare part data.

3. The method of claim 1, wherein said step of generating a wear index includes an additive model.

4. The method of claim 1, wherein said step of generating a wear index further includes computing a wear index for each as set in said asset data.

5. A program storage device readable by machine, tangibly embodying a program of instructions executable by the machine to perform method steps for lifetime estimation of assets, the method steps comprising:
inputting asset data into a system;
generating a wear index for an asset based on said asset data;
computing an amount of wear of an asset based on said wear index; and
generating a remaining life of said asset based on said amount of wear.

6. The program storage device of claim 5, wherein said asset data includes spare part data.

7. The program storage device of claim 5, wherein said method step of generating a wear index includes an additive model.

8. The program storage device of claim 5, wherein said method step of generating a wear index further includes computing a wear index for each asset in said asset data.
